(19) United States
(12) Patent Application Publication
(10) Pub. No.: US 2002/0128022 A1
(43) Pub. Date: Sep. 12, 2002

(54) Alternate directory number on outbound calls

(76) Inventor: David K. Whitezel, Naperville, IL (US)

Correspondence Address: Reginald J. Hill, R.J. Hill & Associates, Ltd., Suite 1402, 19 South LaSalle Street, Chicago, IL, 60603, US

(21) Appl. No.: 09/803,625

(22) Filed: Mar. 9, 2001

(51) Int. Cl. H04Q 7/20

(52) U.S. Cl. 455/461; 455/465; 455/426; 455/560

(57) ABSTRACT

A communications line (110) or device (202) has at least two telephone numbers associated therewith for outbound calls. A processor (102, 210) associated with the communications line or device substitutes a default telephone number for an alternate telephone number as the directory number in data associated with calls that are transmitted to a telephone network (114). The alternate telephone number and a name associated with the alternate telephone number are displayed to the called party via a CNAM.

### FIELD OF THE INVENTION

The present invention relates generally to telecommunications systems, and in particular, to enabling a communications line or device to use an alternate directory number on outbound calls.

### BACKGROUND OF THE INVENTION

Many home-based businesses have a single telephone line or device that is used for both business and personal calls. When a single line or device is used in a home-based business, business and personal calls are made to and from one telephone number that is associated with the line or device. Typically, the telephone number is a home number that is, alternatively, used as a business number. Therefore, if a call is made for business purposes, the home telephone number becomes available to the called party for future use by means of caller identification, calling name (CNAM), or an automatic call back service that is provided by a local phone service provider. As a result, the owner of the home-based business has less privacy during non-business hours since business associates and solicitors have access to the number.

An owner of a home-based business may have multiple lines or devices to separate the personal calls from the business calls. Thus, if a call is made for business purposes, then only the telephone number that is associated with the line or device for business calls will be revealed to the called party. As a result, the owner has more privacy during non-business hours. Moreover, the personal and business calls are billed separately. However, the purchase of multiple lines or devices can be costly, especially when a customer only needs the additional telephone number for infrequent use.

Therefore, a need exists to enable a communications line or device to have an alternate directory number for outbound calls.

### SUMMARY OF THE INVENTION

The present invention enables a communications line or device to have an alternate directory number for outbound calls. A communications line is associated with a telecommunications switch for incoming and outgoing calls. The line is preferably coupled to customer premise equipment, for example, a telephone. A default telephone number is associated with the line for incoming calls. Also, an equipment identifier is associated with the line. The default number and an alternate telephone number are associated with the equipment identifier for calls made to a telephone network. Typically, the default number is the directory number that is transmitted to the telephone network in data associated with calls originating from the communications line. For example, when a user of the communications line makes a call, the default number is revealed to the called party by means of one of caller identification or CNAM. The telecommunications switch coupled to the communications line includes a processor. At the request of the user, the processor substitutes the default number for the alternate number as the directory number in data associated with calls that are transmitted to the telephone network. Preferably, the request is made by dialing a predetermined sequence of key digits on the customer premise equipment coupled to the line. As a result of the substitution, the alternate number is displayed to the called party since the alternate number replaced the default number as the directory number.

A wireless communications device, such as a cellular telephone, has an equipment identifier associated with the device. A default telephone number and an alternate telephone number are associated with the equipment identifier for calls made to the telephone network. For example, a user of the wireless communications device will be separately billed for calls made from the alternate number and the default number. Typically, the default number is the directory number that is transmitted to the telephone network in data associated with calls from the wireless communications device. For example, when a call is made from the wireless communications device, the default number is revealed to the called party by means of one of caller identification or CNAM. A mobile switching center is coupled to the wireless communications device over-the-air through a base station in a manner known in the art. The mobile switching center includes a processor that receives a request from a user of the wireless communications device to substitute the default number for the alternate number as the directory number in data associated with calls that are transmitted to the telephone network. Preferably, a user of the wireless communications device dials a predetermined sequence of key digits on the wireless device to make the request. The processor substitutes the alternate number as the directory number. As a result of the substitution, the alternate number is displayed to the called party instead of the default number.

A method is provided for enabling a communications line or device to have an alternate telephone number as the directory number for outbound calls in accordance with the present invention. First, a user of a communications line or wireless communications device dials a predetermined sequence of key digits to substitute a default telephone number for an alternate telephone number as the directory number that is associated with the line or device. The default telephone number is the directory number that is typically transmitted from a telecommunications switch coupled to the line or device to the telephone network in data associated with calls. The user of the communications line preferably dials the predetermined digits on customer premise equipment, for example, a telephone that is coupled to the line. Then, a processor associated with the line or device receives a signal that is associated with the predetermined sequence of key digits to substitute a default telephone number for an alternate telephone number. The processor substitutes the alternate number as the directory number in data associated with a call that is transmitted to the telephone network. The alternate number is displayed to the called party.

### BRIEF DESCRIPTION OF THE DRAWINGS

FIG. 1 is a block diagram of a telephone switching system in accordance with the present invention.

FIG. 2 is a block diagram of a preferred embodiment of a wireless communications system in accordance with the present invention.

FIG. 3 is a flow chart illustrating a method for enabling a communications line or device to use an alternate directory number on outbound calls in accordance with the present invention.

### DETAILED DESCRIPTION OF THE PREFERRED EMBODIMENTS

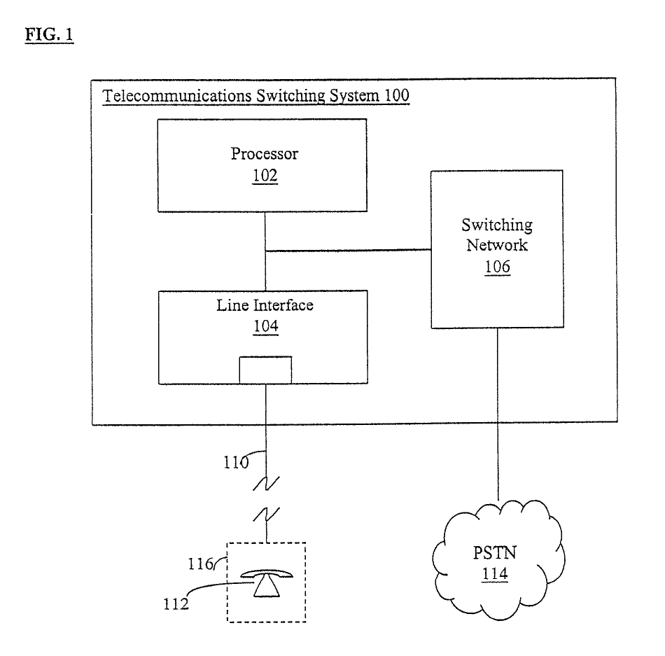

FIG. 1 is a block diagram of a telephone switching system in accordance with the present invention. Telephone switching system 100 is programmable, including hardware and software components for operation. System 100 includes a processor 102, a line interface unit 104, switching network 106, line 110, and trunks 108. System 100 serves as an interface between customer premises equipment 112 and the public switched telephone network (PSTN) 114. Customer premise equipment 112 is preferably a telephone. In a preferred embodiment, telephone switching system 100 is a 5ESS® switching system from Lucent Technologies Inc.

Processor 102 provides control over the functions of system 100. Though processor 102 is shown as a single processor block, processor 102 is alternatively, a single or multiple processors interconnected. Similarly, line interface unit 104 is shown as one block but may consist of multiple components or a single component capable of interfacing with multiple lines. In accordance with the present invention, processor 102 executes software code to perform the function of replacing a default telephone number with an alternate telephone number as the directory number in data associated with calls that are transmitted from line 110 to PSTN 114.

Line interface unit 104 interfaces communications line 110 with system 100. Line 110 is coupled to customer premise equipment 112, which is located on a customer's premises 116. Switching network 106 interfaces system 100 with PSTN 114. By virtue of network 106, customer premise equipment 112 is coupled to PSTN 114 for communications, including voice and data communications.

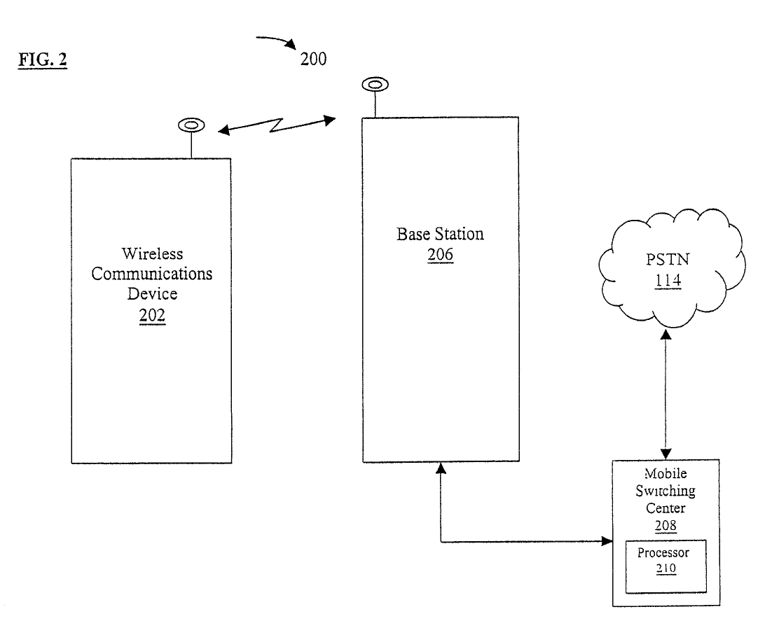

FIG. 2 is a block diagram of a wireless telecommunications system in accordance with the present invention. Wireless telecommunications system 200 includes wireless communications device 202, base station 206, mobile switching center (MSC) 208 and public switched telephone network (PSTN) 114. Wireless communications device 202 communicates with base station 206 over-the-air. Device 202 is preferably a wireless or cellular telephone. Base station 206 receives a request from device 202 to substitute the default telephone number with an alternate number as the directory number that is associated with the device. Base station 206 extends the request to MSC 208. Base station 206 is coupled to MSC 208 via data links.

MSC 208 is coupled to wireless communications device 202 over-the-air through base station 206. MSC 208 includes processor 210 for controlling the functions of device 202. Though processor 210 is shown as a single block, processor 210 is alternatively, a single or multiple processors interconnected. In accordance with the present invention, processor 210 executes software code to perform the function of substituting the alternate telephone number as the directory number in data associated with calls that are transmitted from wireless communications device 202 to PSTN 114. MSC 208 interfaces PSTN 114 for transmitting calls to and from the telephone network.

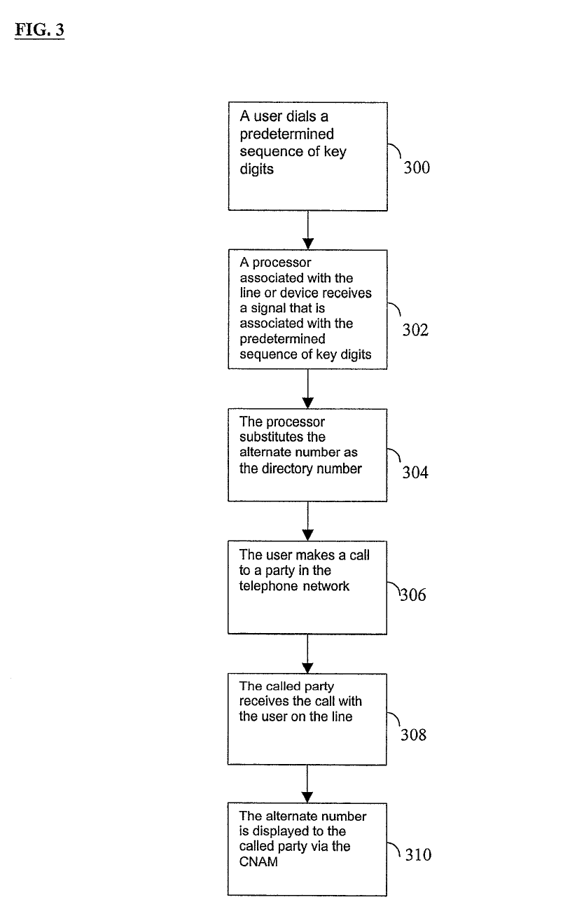

FIG. 3 is a flow chart illustrating a method for enabling a communications line or device to use an alternate directory number on outbound calls in accordance with the present invention. The method is described with reference to the embodiments shown in FIGS. 1 and 2. First, a user dials a predetermined sequence of key digits to replace a directory number (300). This is accomplished by dialing a predetermined sequence of key digits on customer premise equipment 112 or on wireless communications device 200. Second, a processor associated with the line or device receives a signal that is associated with the predetermined sequence of key digits to substitute a default telephone number for an alternate telephone number as the directory number in data associated with calls that are transmitted to a telephone network (302). This is accomplished in the preferred embodiment by transmitting a signal that is associated with the predetermined sequence of key digits to a processor associated with line 110 or device 202. Third, the processor substitutes the alternate number as the directory number in data associated with a call that is transmitted to the telephone network (304). Preferably, the processor runs a software program that locates and assigns data that is associated with the alternate telephone number to line 110 or device 202. Then, the user makes a call to a party in the telephone network (306). This is accomplished in the preferred embodiment by dialing a predetermined sequence of key digits on customer premises equipment 112 or device 202. Then, the called party receives the call with the user on the line (308). And, the alternate number and a name associated with the alternate number are displayed to the called party by means of one of caller identification or CNAM (310).

The request to substitute the alternate number as the directory is alternatively made on a per call basis or is made for all calls until changed. Also, an alternate number designation may be pre-subscribed permanently or for a predetermined period of time by contacting a local service provider. Where the alternate telephone number is used as the directory number, all automatic call back functions and caller id functions display and refer to the alternate number, rather than the actual telephone number associated with the line or device. This permits substitution of the alternate number for the directory number in all functions requiring the directory number, including billing. Hence, calls made with the alternate number may be billed to the alternate number, rather than the directory number. Also, database functions associated caller identification and the like, for example, database lookups to determine a name associated with a directory number by a terminating telecommunications switch, use the alternate number rather than the actual telephone number associated with the communications line or device.

Incoming calls to the alternate number may be terminated by a communications line, a communications device, voice mail or any alternative desired for answering calls. Thus, in the case of the home-based business, calls made from the home will not display the home number, but will display a business number that is available to accept incoming business calls.

The present invention enables a communications line or device to use an alternate telephone number as the directory number in data associated with calls that are transmitted to the telephone network. At the request of a user of the line or device, a processor that is associated with the line or device substitutes a default telephone number, which is the directory number for inbound and outbound calls, with the alternate telephone number. Advantageously, users can make business calls from a single communications line or device without revealing their home number.

Whereas the present invention has been described with respect to specific embodiments thereof, it will be understood that various changes and modifications will be suggested to one skilled in the art and it is intended that the invention encompass such changes and modifications as fall within the scope of the appended claim.

1. A telecommunications switch comprising:
at least one communications line having an equipment identifier associated therewith, wherein a default telephone number and an alternate telephone number are associated with the equipment identifier and wherein a directory number is sent in data associated with calls from the at least one communications line; and
a processor associated with the at least one communications line that:
receives a request to substitute the default telephone number with the alternate telephone number to serve as the directory number for the at least one communications line; and
substitutes the alternate telephone number as the directory number in data associated with a call that is transmitted to a telephone network.

2. The telecommunications switch of claim 1 wherein the default telephone number is associated with the at least one communications line for incoming calls.

3. The telecommunications switch of claim 2 wherein the alternate telephone number is associated with another communications line for incoming calls.

4. The telecommunications switch of claim 1 wherein the default telephone number and the alternate telephone number are associated with the equipment identifier for billing such that calls associated with the equipment identifier are billed to the alternate telephone number or the default telephone number.

5. A mobile switching center that couples a plurality of communications devices to a telephone network for incoming and outgoing calls, wherein the mobile switching center sends a directory number in data sent with outgoing calls to the telephone network to identify the communications device, the mobile switching center comprising:
a processor that:
receives a request from a communications device to substitute a default telephone number with an alternate telephone number to serve as the directory number for the communications device; and
substitutes the alternate telephone number as the directory number in data associated with a call that is transmitted to the telephone network.

6. The mobile switching center of claim 5 wherein an equipment identifier is associated with the communications device.

7. The mobile switching center of claim 6 wherein the default telephone number and the alternate telephone number are associated with the equipment identifier.

8. The mobile switching center of claim 7 wherein the default telephone number and the alternate telephone number are associated with the equipment identifier for billing.

9. The mobile switching center of claim 5 wherein the communications device is a wireless telephone.

10. The mobile switching center of claim 5 wherein the default telephone number is associated with the communications device for incoming calls.

11. The mobile switching center of claim 10 wherein the alternate telephone number is associated with another communications device or communications line for incoming calls.

12. A method for enabling a communications device to select a directory number that is transmitted in data on outbound calls to identify the communications device, the method comprising the steps of:
receiving a signal associated with a predetermined sequence of key digits entered on the communications device, wherein the signal is a request to substitute a default telephone number with an alternate telephone number to serve as the directory number for an outbound call from the communications device; and
substituting the alternate telephone number as the directory number in data associated with a call that is transmitted to the telephone network.

13. The method of claim 12 wherein the communications device is a wireless telephone.

14. The method of claim 12 wherein an equipment identifier is associated with the communications device.

15. The method of claim 12 wherein the default telephone number and the alternate telephone number are associated with the equipment identifier.

16. The method of claim 12 wherein the default telephone number is associated with the communications device for incoming calls.

17. The method of claim 16 wherein the alternate telephone number is associated with another communications device for incoming calls.

18. The method of claim 14 wherein the communications device is a customer premise equipment coupled to a telecommunications switch by a communications line and the communications line is associated with the equipment identifier.

19. The method of claim 18 wherein the default telephone number is associated with the communications line for incoming calls.

20. The method of claim 19 wherein the alternate telephone number is associated with another communications line for incoming calls.
